(19) United States
(12) Patent Application Publication
(10) Pub. No.: US 2020/0241169 A1
(43) Pub. Date: Jul. 30, 2020

(54) METHOD FOR DETERMINING INTERNAL STRESS OF SOLID-CUT-AND-FILL MATERIAL

(71) Applicant: CHINA UNIVERSITY OF MINING AND TECHNOLOGY, Jiangsu (CN)

(72) Inventors: Meng Li, Jiangsu (CN); Jixiong Zhang, Jiangsu (CN); A.J.S. (Sam) Spearing, Jiangsu (JP); Zhongya Wu, Jiangsu (CN); Nan Zhou, Jiangsu (CN); Feng Gao, Jiangsu (CN)

(21) Appl. No.: 16/756,819

(22) PCT Filed: Apr. 18, 2019
(86) PCT No.: PCT/CN2019/083209

§ 371 Date: Apr. 16, 2020

(30) Foreign Application Priority Data
Sep. 6, 2018 (CN) 201811034412.1

(51) Int. Cl. G01V 99/00; G06F 30/20

(52) U.S. Cl. CPC G01V 99/005; G06F 2111/10; G06F 30/20

(57) ABSTRACT

The present invention discloses a method for determining internal stress of a solid filling material, comprising the following steps: step 1) acquiring stress data of the solid filling material, and fitting the stress-strain relationship of the solid filling material; step 2) calculating surface subsidence in the solid filling area on the basis of an equivalent mining height theory with a probability integration method; step 3) calculating the expansion height of fractured zones in the area under a solid-backfill coal mining condition; step 4) calculating the strain in the solid filling material at a distance L from the rear of the stope by combing with step 2) and step 3); step 5) calculating internal stress in the solid filling material at distance L from the rear of the working face. The present invention attains the following beneficial effects: the present invention provides a method for calculating the stress in filling mass for solid-backfill coal mining. The method is simple and practical, and is of great significance for reckoning the distribution of the stress in the surrounding rock for solid backfill mining, guiding the backfill mining support design, and enriching the backfill mining pressure theory system.

### TECHNICAL FIELD

The present invention relates to a method for determining the internal stress of a solid filling material.

### BACKGROUND ART

China is the largest coal producing country in the world. As the coal resources are mined intensively, the coal mining in China has gradually entered an exhaustion period. Especially, in the eastern region of China, a challenge of coal mining under buildings, railways and water-bodies is encountered. Backfill mining can realize safe mining of coal resources under buildings, railways, and water bodies, and is a green mining method with low environmental damage.

Although the technology and theory of backfill coal mining are relatively rich after decades of development, there is little research on the calculation methods of the stress of goaf filling mass in solid backfill mining.

### CONTENT OF THE INVENTION

In order to overcome the drawbacks in the prior art, the present invention provides a method for determining the internal stress of a solid filling material, which can be used to guide the support design for backfill mining, enriches the mining pressure theory system of backfill coal mining, and is of great significance.

In order to attain the object described above, the present invention employs the following technical solution:

A method for determining internal stress of a solid filling material, comprising the following steps:

step 1) acquiring stress data of the solid filling material, and fitting stress-strain relationship of the solid filling material;

step 2) calculating surface subsidence in the solid filling area on the basis of an equivalent mining height theory with a probability integration method;

step 3) calculating expansion height of fractured zones in the area under a solid-backfill coal mining condition;

step 4) calculating strain in the solid filling material at a distance L from the rear of the stope by combining with step 2) and step 3);

step 5) calculating internal stress in the solid filling material at distance L from the rear of the working face.

In the method for determining internal stress of a solid filling material described above, the step 1) specifically comprises:

acquiring parameter data of displacement, force, and compaction systems in the process of compaction through solid filling material compaction tests, and fitting stress-strain relationship of the solid filling material.

In the method for determining internal stress of a solid filling material described above, a stress-strain relationship is expressed as: σᵥ=aεᵥ+bεᵥ³ wherein, σᵥ represents internal vertical stress of the solid filling material; εᵥ represents the strain of the solid filling material in the vertical direction; a and b are constant coefficients.

In the method for determining the internal stress of a solid filling material described above, the specific calculation process of the surface subsidence in the solid filling area in the step 2) is:

equivalent mining height Mₑ=Mₜ+M_{c}, wherein, Mₜ represents the advance subsidence of the roof; M_{c} represents the amount of compression of the filling mass;

the surface subsidence in the solid filling area is

$$W ( L ) = \frac{{W}_{m}}{2} ( erf ( \frac{\sqrt{π}}{r} L ) + 1 ) ,$$

wherein, Wₘ represents maximum surface subsidence; r represents the scope of influence of surface subsidence;

$$erf ( \frac{\sqrt{π}}{r} L )$$

represents an error function calculated by a formula of

$$erf ( \frac{\sqrt{π}}{r} L ) = \frac{2}{\sqrt{π}} {\int }_{0}^{\frac{\sqrt{π}}{r} L} {e}^{- {λ}^{2}} d λ ;$$

the formula for maximum surface subsidence is Wₘ=qMₑ cos α, wherein q represents a subsidence coefficient, and α represents the dip angle of the coal seam; the formula for scope of influence of surface subsidence is r=H/tan β, wherein H represents burial depth, and β represents a major influence angle.

In the method for determining the internal stress of a solid filling material described above, the expansion height in the step 3) is calculated according to an equivalent mining height principle of backfill mining in combination with the height of development of the fractured zones in the mining with a caving method, or is determined through physical similarity simulation tests.

In the method for determining the internal stress of a solid filling material described above, when the expansion height is calculated according to the equivalent mining height principle of backfill mining in combination with the height of development of the fractured zones in the mining with a caving method:

the height of development of the fractured zone in mining with a caving method is calculated with the following empirical formula:

$${H}_{f} = \frac{100 M}{cM + d} ,$$

wherein c, d represent coefficients determined according to the lithology of the roof;

a formula of the height of development of the fractured zones in solid-backfill coal mining is obtained according to the height of development in combination with the equivalent mining height principle of backfill mining;

a fractured zone undergoes volumetric expansion in the process of formation; suppose the expansion coefficient of the fractured zone is k, then the expansion height in the vertical direction is

$${S}_{f} = k \frac{100 {M}_{e}}{{cM}_{e} + d} .$$

In the method for determining the internal stress of a solid filling material described above, when the expansion height is calculated according to the equivalent mining height principle of backfill mining in combination with the height of development of the fractured zones in the mining with a caving method, the coefficients c, d determined according to the lithology of the roof are selected with the following table:

| | Uniaxial compressive strength | | |
|---|---|---|---|
| Lithology | (MPa) | c | d |
| Rigid | >40 | 1.2 | 2.0 |
| Moderate strength | 20-40 | 1.6 | 3.6 |
| Soft and weak | 10-20 | 3.1 | 5.0 |
| Weathered and broken | <10 | 5.1 | 8.0 |

In the method for determining the internal stress of a solid filling material described above, the specific content of the step 4) is:

the compression deformation S_{L} of the solid filling material at distance L from the rear of the working face is S_{L}=W_{L}+S_{f}, wherein W_{L} represents the surface subsidence at distance L from the rear of the working face; S_{f} represents the expansion height of the fractured zones in the vertical direction at distance L from the rear of the working face;

the strain of the solid filling material at distance L from the rear of the working face is calculated as

$${ɛ}_{L} = \frac{{S}_{L}}{M} ,$$

then the strain of the solid filling material at distance L from the rear of the stope is

$${ɛ}_{L} = \frac{{S}_{L}}{M} = \frac{\frac{q {M}_{e} cos α}{2} ( erf ( \frac{\sqrt{π}}{r} L ) + 1 ) + \frac{100 {kM}_{e}}{{cM}_{e} + d}}{M} .$$

In the method for determining the internal stress of a solid filling material described above, the specific content of the step 5) is:

the vertical stress of the filling mass is calculated by substituting formula of the strain of the solid filling material at distance L from the rear of the stope into the stress-strain fitting formula of the solid filling material in compaction test:

$${σ}_{v} = a ( \frac{\frac{q {M}_{e} cos α}{2} ( erf ( \frac{\sqrt{π}}{r} L ) + 1 ) + \frac{100 k {M}_{e}}{c {M}_{e} + d}}{M} ) + {b ( \frac{\frac{q {M}_{e} cos α}{2} ( erf ( \frac{\sqrt{π}}{r} L ) + 1 ) + \frac{100 k {M}_{e}}{c {M}_{e} + d}}{M} )}^{3} ;$$

the internal stress of the solid filling material at distance L from the rear of the working face is calculated as follows on the basis of the equivalent mining height calculation formula:

$${σ}_{v} = a ( \frac{\begin{matrix}\frac{q ( ( M - {M}_{t} ) {ɛ}_{v} ( γ H ) + {M}_{t} ) cos α}{2} ( erf ( \frac{\sqrt{π}}{r} L ) + 1 ) + \\ \frac{100 k ( ( M - {M}_{t} ) {ɛ}_{v} ( γ H ) + {M}_{t} )}{c ( ( M - {M}_{t} ) {ɛ}_{v} ( γ H ) + {M}_{t} ) + d}\end{matrix}}{M} ) + {b ( \frac{\begin{matrix}\frac{q ( ( M - {M}_{t} ) {ɛ}_{v} ( γ H ) + {M}_{t} ) cos α}{2} ( erf ( \frac{\sqrt{π}}{r} L ) + 1 ) + \\ \frac{100 k ( ( M - {M}_{t} ) {ɛ}_{v} ( γ H ) + {M}_{t} )}{c ( ( M - {M}_{t} ) {ɛ}_{v} ( γ H ) + {M}_{t} ) + d}\end{matrix}}{M} )}^{3} .$$

Benefits: the present invention provides a method for calculating the stress in filling mass for solid-backfill coal mining. The method is simple and practical, and is of great significance for reckoning the distribution of the stress in the surrounding rock for solid backfill mining, guiding the backfill mining support design, and enriching the backfill mining pressure theory system.

### BRIEF DESCRIPTION OF DRAWINGS

FIG. 1 shows the steps of calculation of the stress of the solid filling material;

FIG. 2 is a schematic diagram of the deformation of the solid filling material;

FIG. 3 shows the height of development of fractured zones of the solid filling material in the filling area;

FIG. 4 is a stress-strain diagram of the solid filling material;

FIG. 5 is a schematic layout plan of the monitoring devices.

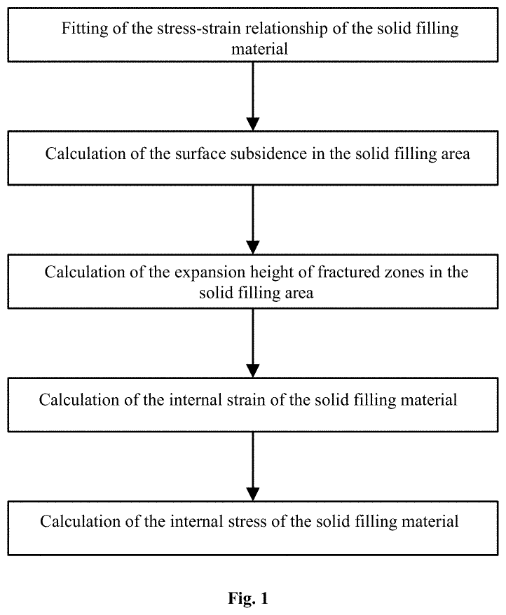

### EMBODIMENTS

Hereunder the present invention will be further detailed, with reference to the accompanying drawings. The following embodiments are used only for explaining the technical solution of the present invention more clearly rather than constituting any limitation to the scope of protection of the present invention.

The specific steps for implementing the present invention are as follows:

A. fitting of stress-strain relationship of the solid filling material; B. calculation of surface subsidence in the solid filling area; C. calculation of the expansion height of fracture zones in the solid filling area; D. calculation of internal strain of the solid filling material; E. calculation of the internal stress of the solid filling material.

Background of the embodiment: mining at a working face CT120 in a mine under a village, by solid filling mining with the gangue accumulated on the ground surface of the mine. The coal seam where the working face is located is at a burial depth of 390 meters, the dip length of the panel area is 115 meters, the strike length is 410 meters, the average thickness of the coal seam is 3.3 meters, and the dip angle is 4°. The immediate roof is shale in an average thickness of 5.1 meters, the main roof is sandstone in an average thickness of 33 meters, and the floor is mudstone in an average thickness of 14.8 meters.

Specifically, the fitting of the stress-strain relationship of the solid filling material in the step 1) is as follows:

The filling material for the mine is gangue material with particle size smaller than 50 mm, the test samples are directly taken from the filling material for the mine shaft, 5 kg gangue filling material is taken for each sample group, and the samples are grouped into three groups. The filling material is compacted with a compactor system, the pressure and displacement curve are logged and exported, and the data is fitted with Matlab software to determine the stress-strain relationship of the gangue filling material.

Specifically, the calculation of the surface subsidence and expansion height of fracture zones in the solid filling area in the step 2) and step 3) is as follows:

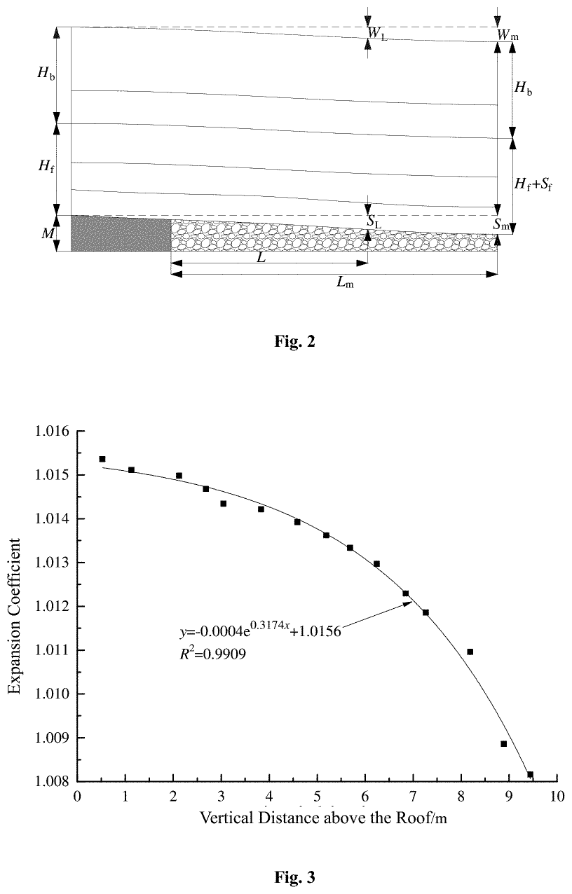

The overlying strata has medium strength, with bulk modulus of 25 kN/m³. The self-weight stress is about 9.8 MPa. In the mining process, the average subsidence of the roof in advance is 80 mm. The surface subsidence corresponding to the working face can be calculated with a probability integration method based on an equivalent mining height principle. Wherein the surface subsidence coefficient is determined as 0.73, and the tangent value of the major influence angle is 1.8. A schematic diagram of the deformation of the filling mass is shown in FIG. 2. The expansion coefficient of fractured zone is obtained through a similarity simulation test. The parameters are shown in FIG. 3.

In the step 4)-5), the internal strain and stress of the solid filling material are calculated as follows:

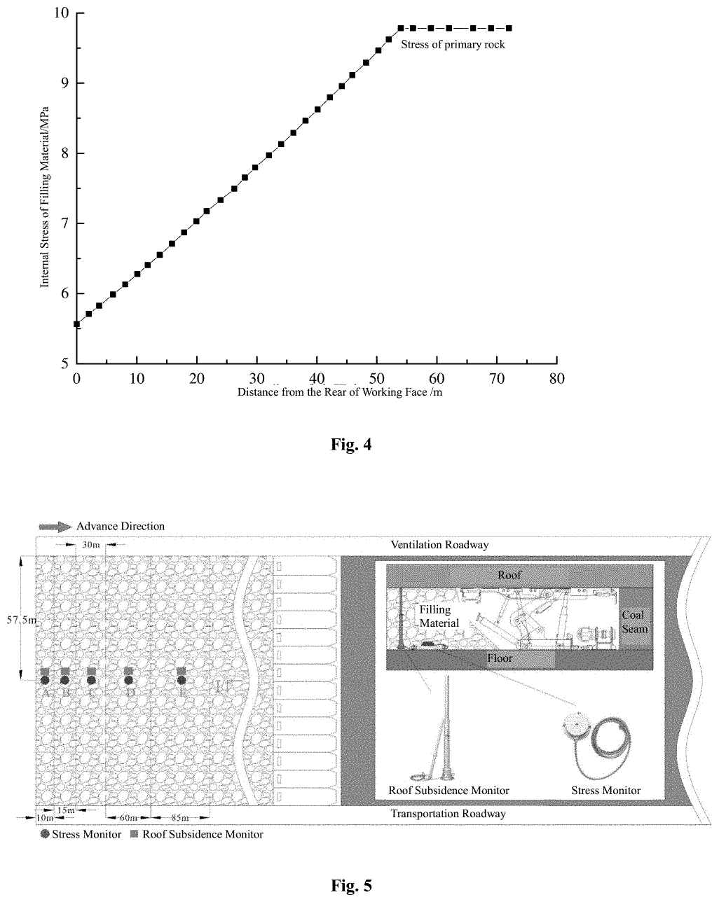

In the advance process of the working face, the stress in the filling mass can be obtained by substituting the above parameters into the formula. The relation of the stress vs. the advance of the working face is shown in FIG. 4.

Finally, the stress is monitored on site. It is seen from the field measurement result in the mine: the above calculation result is essentially in line with the measured data, and may be used to predict the stress condition of the filling mass in a fully compacted state. A schematic layout plan of the monitoring devices is shown in FIG. 5.

While the present invention is described above in some preferred embodiments, it should be noted that those skilled in the art can make various improvements and modifications without departing from the technical principle of the present invention, and those improvements and modifications should be deemed as falling in the scope of protection of the present invention.

1. A method for determining internal stress of a solid filling material, comprising the following steps:
step 1) acquiring stress data of the solid filling material, and fitting stress-strain relationship of the solid filling material;
step 2) calculating surface subsidence in the solid filling area on the basis of an equivalent mining height theory with a probability integration method;
step 3) calculating expansion height of fractured zones in the area under a solid-backfill coal mining condition;
step 4) calculating strain in the solid filling material at a distance L from the rear of a stope by combing with step 2) and 3);
step 5) calculating internal stress in the solid filling material at distance L from the rear of a working face.

2. The method for determining internal stress of a solid filling material according to claim 1, wherein the step 1) comprises:
acquiring parameter data of displacement, force, and compaction systems in the process of compaction through solid filling material compaction tests, and fitting the stress-strain relationship of the solid filling material.

3. The method for determining internal stress of a solid filling material according to claim 2, wherein the stress-strain relationship is expressed as: σᵥ=aεᵥ+bεᵥ³, wherein, σᵥ represents the internal vertical stress of the solid filling material; εᵥ represents the strain of the solid filling material in the vertical direction; a and b are constant coefficients.

4. The method for determining internal stress of a solid filling material according to claim 1, wherein the specific calculation process of the surface subsidence in the solid filling area in the step 2) is:
equivalent mining height Mₑ=Mₜ+M_{c}, wherein, Mₜ represents the subsidence of the roof in advance; M_{c} represents the amount of compression of the filling mass;
the surface subsidence in the solid filling area is
$$W ( L ) = \frac{{W}_{m}}{2} ( erf ( \frac{\sqrt{π}}{r} L ) + 1 ) ,$$
wherein, Wₘ represents maximum surface subsidence; r represents the scope of influence of surface subsidence;
$$erf ( \frac{\sqrt{π}}{r} L )$$
represents an error function calculated by a formula of
$$erf ( \frac{\sqrt{π}}{r} L ) = \frac{2}{\sqrt{π}} {\int }_{0}^{\frac{\sqrt{π}}{r} L} {e }^{- {λ}^{2}} d λ ;$$
the maximum surface subsidence is Wₘ=qMₑ cos α, wherein q represents a subsidence coefficient, and α represents a dip angle of coal seam; the formula for scope of influence of surface subsidence is r=H/tan β, wherein H represents a burial depth, and β represents a major influence angle.

5. The method for determining internal stress of a solid filling material according to claim 1, wherein the expansion height in the step 3) is calculated according to an equivalent mining height principle of backfill mining in combination with a height of development of the fractured zones in the mining with a caving method, or is determined through physical similarity simulation tests.

6. The method for determining internal stress of a solid filling material according to claim 5, wherein when the expansion height is calculated according to the equivalent mining height principle of backfill mining in combination with the height of development of the fractured zones in the mining with the caving method:
the height of development of the fractured zone in mining with the caving method is calculated with the following empirical formula:
$${H}_{f} = \frac{100 M}{cM + d} ,$$
wherein c, d represent coefficients determined according to the lithology of the roof;
a formula of the height of development of the fractured zones in solid-backfill coal mining is obtained according to the equivalent mining height principle of backfill mining in combination with the height of development;
the fractured zone undergoes volumetric expansion in the process of formation; suppose the expansion coefficient of the fractured zone is k, then the expansion height in the vertical direction is
$${S}_{f} = k \frac{100 {M}_{e}}{{cM}_{e} + d} .$$

7. The method for determining internal stress of a solid filling material according to claim 6, wherein when the expansion height is calculated according to the equivalent mining height principle of backfill mining in combination with the height of development of the fractured zones in the mining with the caving method, the coefficients c, d determined according to the lithology of the roof are selected with the following table:

| | Uniaxial compressive strength | | |
|---|---|---|---|
| Lithology | (MPa) | c | d |
| Rigid | >40 | 1.2 | 2.0 |
| Moderate strength | 20-40 | 1.6 | 3.6 |
| Soft and weak | 10-20 | 3.1 | 5.0 |
| Weathered and broken | <10 | 5.1 | 8.0 |

8. The method for determining internal stress of a solid filling material according to claim 1, wherein the specific content of the step 4) is:
the compression deformation S_{L} of the solid filling material at distance L from the rear of the working face is S_{L}=W_{L}+S_{f}, wherein W_{L} represents the surface subsidence at distance L from the rear of the working face; S_{f} represents the expansion height of the fractured zones in the vertical direction at distance L from the rear of the working face;
the strain of the solid filling material at distance L from the rear of the working face is calculated as
$${ɛ}_{L} = \frac{{S}_{L}}{M} ,$$
then the strain of the solid filling material at distance L from the rear of the stope is
$${ɛ}_{L} = \frac{{S}_{L}}{M} = \frac{\frac{q {M}_{e} cos α}{2} ( erf ( \frac{\sqrt{π}}{r} L ) + 1 ) + \frac{100 {kM}_{e}}{{cM}_{e} + d}}{M} .$$

9. The method for determining internal stress of a solid filling material according to claim 8, wherein the specific content of the step 5) is:
the vertical stress of the filling mass is calculated by substituting formula of the strain of the solid filling material at distance L from the rear of the stope into the stress-strain fitting formula of the solid filling material in compaction test:
$${σ}_{v} = a ( \frac{\frac{q {M}_{e} cos α}{2} ( erf ( \frac{\sqrt{π}}{r} L ) + 1 ) + \frac{100 {kM}_{e}}{{cM}_{e} + d}}{M} ) + {b ( \frac{\frac{q {M}_{e} cos α}{2} ( erf ( \frac{\sqrt{π}}{r} L ) + 1 ) + \frac{100 {kM}_{e}}{{cM}_{e} + d}}{M} )}^{3} ;$$
the internal stress of the solid filling material at distance L from the rear of the working face is calculated as follows on the basis of the equivalent mining height calculation formula:
$${σ}_{v} = a ( \frac{\begin{matrix}\frac{q ( ( M - {M}_{t} ) {ɛ}_{v} ( γ H ) + {M}_{t} ) cos α}{2} ( erf ( \frac{\sqrt{π}}{r} L ) + 1 ) + \\ \frac{100 k ( ( M - {M}_{t} ) {ɛ}_{v} ( γ H ) + {M}_{t} )}{c ( ( M - {M}_{t} ) {ɛ}_{v} ( γ H ) + {M}_{t} ) + d}\end{matrix}}{M} ) + {b ( \frac{\begin{matrix}\frac{q ( ( M - {M}_{t} ) {ɛ}_{v} ( γ H ) + {M}_{t} ) cos α}{2} ( erf ( \frac{\sqrt{π}}{r} L ) + 1 ) + \\ \frac{100 k ( ( M - {M}_{t} ) {ɛ}_{v} ( γ H ) + {M}_{t} )}{c ( ( M - {M}_{t} ) {ɛ}_{v} ( γ H ) + {M}_{t} ) + d}\end{matrix}}{M} )}^{3} .$$
